(19) United States
(12) Patent Application Publication
(10) Pub. No.: US 2005/0244708 A1
(43) Pub. Date: Nov. 3, 2005

(54) Battery cover for retention of dielectric fluid

(76) Inventor: Michael A. Doyle, Holland, OH (US)

Correspondence Address: FRASER MARTIN BUCHANAN MILLER LLC, 132C WEST SECOND STREET, PERRYSBURG, OH, 43551-1401, US

(21) Appl. No.: 11/108,997

(22) Filed: Apr. 19, 2005

Related U.S. Application Data
(60) Provisional application No. 60/567,478, filed on May 3, 2004.

(51) Int. Cl. H01M 2/12

(52) U.S. Cl. 429/163

(57) ABSTRACT

An improved battery construction for increasing the life of a storage battery by providing a housing integral with the battery case or jar which will condense escaping dielectric fluid and cause the condensed liquid to return to the main supply of dielectric fluid.

### CROSS-REFERENCE TO RELATED APPLICATION

This application claims priority to U.S. provisional application 60/567,478, filed May 3, 2004.

### BACKGROUND OF THE INVENTION

1. Field of the Invention

The invention relates to batteries and, more particularly, to a battery construction for increasing the useful life of a storage battery by a unique battery cover which provides a relatively large area for collecting drops of electrolyte entrained in the gases produced within the battery and returning the electrolyte to the main source.

2. Description of the Prior Art

Various attempts have been made to produce electric storage batteries by providing a filter cap structure that separates and returns the droplets of electrolyte without interfering with the discharge of an effluent gas.

During the operations the operations of lead-acid electric storage batteries, gases are produced within the interior of the battery. More specifically, such batteries are comprised of a casing or jar containing multiple cells each of which contains anodes and cathodes separated by separator plates all immersed in an electrolyte. Such a battery includes a pair of terminals coupled to respective anodes and cathodes. During the operation of the battery, gases are generated from chemical reactions taking place within the battery. These gases entrap and entrain battery electrolyte causing an escape of the electrolyte out of the respective cells of the battery which is detrimental to the battery performance and shortens life expectation.

While it would be ideal to solve the above problem by completely sealing the battery, practically this is impossible due to the pressure of the gases developed within the battery. Such internal pressure required that the battery be vented to accommodate the gases generated within the battery. Obviously, without proper ventilation battery explosion can result.

Vented filter cap and battery covers have been utilized in attempts to overcome the above problem with varying degrees of success. Typical amongst the prior art attempts was the design of a filter cap in the form of a hollow cylinder with small holes in the upper and lower circular faces. The interior of the cylinder was filled with small balls. The droplets of electrolyte condensed on the outer surface of the balls and collected to form larger drops which then were caused to be directed back into the battery cell. This attempt was less efficient than necessary in certain instances.

Other attempts have been made which, due to overloading of the filter caps, have necessitated the development of a structure capable of functioning at the desired and necessary efficiencies.

It is an object of the present invention to produce a novel vented battery cover to capture and return to the battery cell portions of the electrolyte which have heretofore been allowed to escape from the battery cell with the gases produced and vented to the atmosphere.

### SUMMARY OF THE INVENTION

The above as well as other objects and advantages of the invention may typically be achieved by a storage battery including ajar containing an electrolyte and an electrolyte recycling cover characterized by the cover comprising a lid the peripheral edge of which is adapted to be heat sealed to the jar, the lid containing a depending chamber having a perforated floor defining a zone communicating with the interior of the jar wherein electrolyte escaping from the jar may be collected and returned to the jar through the perforations in the housing.

### BRIEF DESCRIPTION OF THE DRAWINGS

The above objects and advantages of the invention, as well as others, will become readily apparent to those skilled in the art from reading the following detailed description of a preferred embodiment of the invention when considered in the light of the accompanying drawings, in which:

FIG. 1 is a fragmentary sectional elevational view of a storage battery containing the structural features of the present invention;

FIG. 2 is a perspective view of the housing illustrated in FIG. 1 for retaining dielectric fluid entrained in gases escaping from the battery cell;

FIG. 3 is a top plan of the housing illustrated in FIG. 2; and

FIG. 4 is a bottom plan view of the lower surface of the housing illustrated in FIGS. 2 and 3;

### DETAILED DESCRIPTION OF THE PREFERRED EMBODIMENT

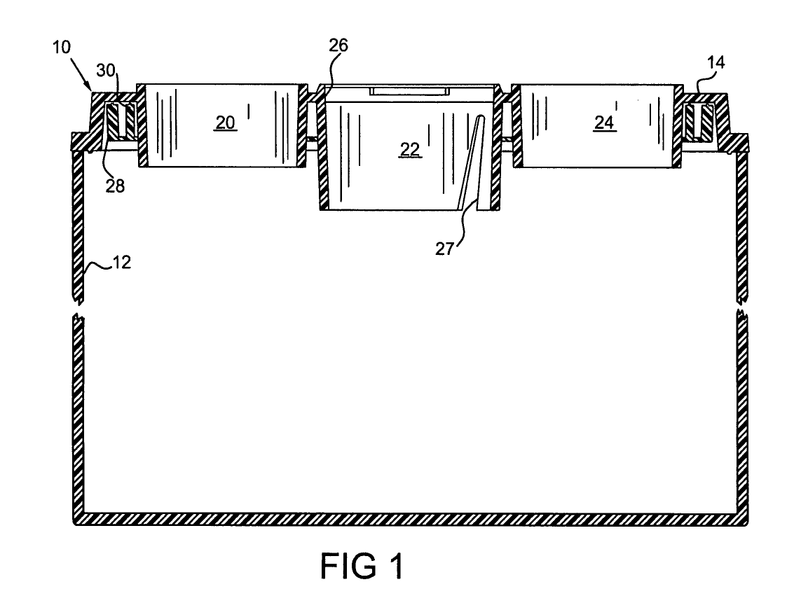

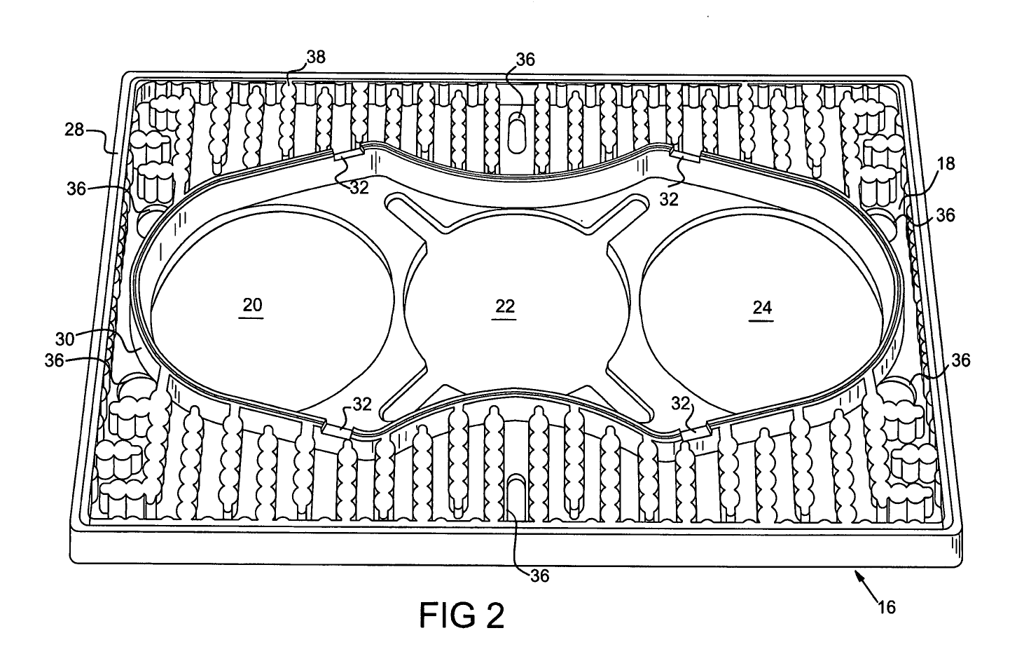

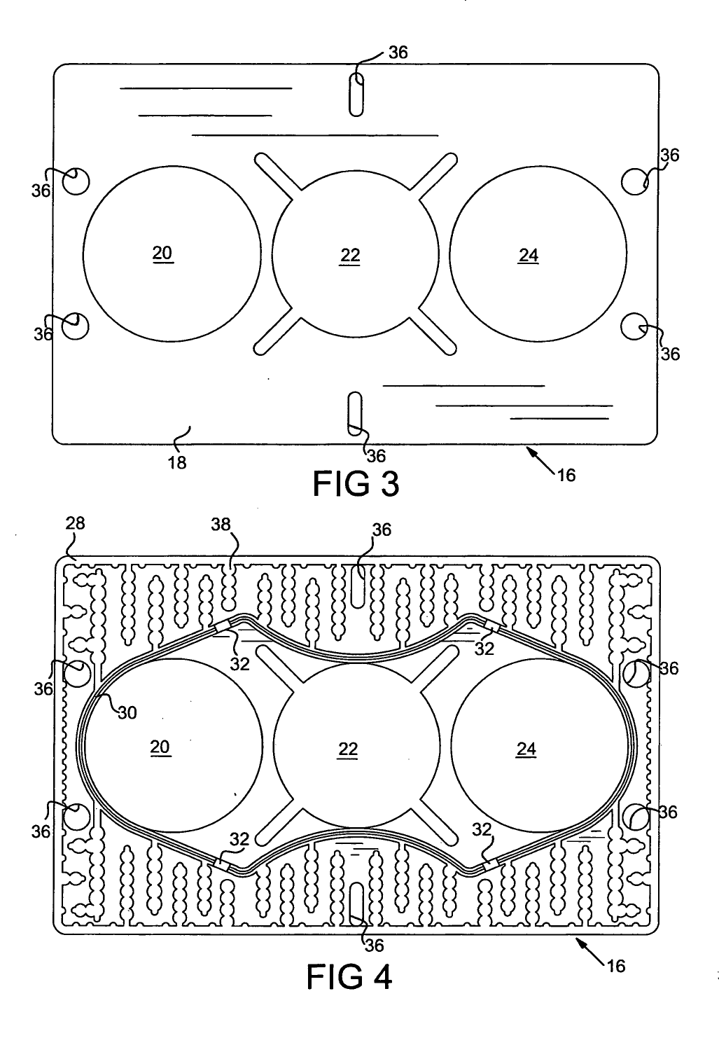

A preferred embodiment of the invention is illustrated in FIGS. 1 through 4, wherein there is shown a storage battery generally indicated by reference numeral 10 which includes ajar or case 12 and an associated covered lid 14. Secured to and depending from the undersurface or the lid 14 is a housing 16. It will be understood that the interior of the jar 12 contains a plurality of cooperating anodes and cathodes separated by a battery plate which in cooperation with respective positive and negative terminals and an appropriate liquid electrolyte form a battery cell. A typical battery cell has a nominal voltage of two (2) volts. A typical commercial or industrial battery is designed to produce twelve (12) volts. Thus, such a battery would contain six cells. However, for the sake of simplicity only a single cell battery is illustrated and described in the present description.

The housing 16 includes a bottom wall 18 having three spaced apart apertures 20, 22, and 24. The endmost apertures 20 and 24 are provided to receive positive and negative terminals attached to the anode and cathode elements (not shown) of the battery 10. The center aperture 22 defines the dielectric fill opening of the battery 10 which typically receives a fill tube 26 closed by a suitable vented cap or cover 26. The fill tube 26 is provided with at least a breather slot 27.

An upstanding wall 28 is adapted to circumferentially surround the bottom wall 18. An inner wall 30 is adapted to surround the apertures 20, 22, and 24. The uppermost edge of the wall 30 is provided with a plurality of spaced apart notches 32. The portion of the bottom wall 18 between the outer wall 28 and the inner wall 30 is provided with a plurality of spaced apart upstanding members 38.

The members 38 are configured to include an outer surface having a large surface area. The members 38 include a central upstanding main body having an outer surface formed with outwardly extending portions. The members 38 are disposed in spaced relation to one another to provide labrynth passageways therebetween. The facing wall surfaces of the members 38 are formed to increase the exposed wall surface area which may be conducted by the transient gases formed during the electrolysis which normally occurs in the known storage batteries.

The preferred embodiment of the invention illustrates the exposed surfaces of the members 38 in the form of a plurality of juxtaposed upstanding cylindrically shaped elements of circular cross-section, generally referred to as right circular cylinders. However, other shapes could be employed such as for example columnar members having rectangular cross-sectional configuration. The main purpose is to increase the overall surface area from a flat planar surface to a surface having outwardly projecting rib sections wherein an increased exposed surface area of the members 38 is produced.

The application of electrical energy to the positive and negative terminals of the storage battery 10 causes chemical reactions within the electrolyte of the battery resulting in the battery becoming charged with electrical energy, thus an electric storage battery. Some of these electrical reactions cause gases such as hydrogen and oxygen to be produced. Hydrogen is typically formed on the anode and oxygen is typically formed on the cathode. These gases accumulate as gas bubbles in the electrolyte rise to the surface of the electrolyte and pass out of the jar 12 through the breather slot 27 in the fill tube 26. These gases are known to entrap and carry battery electrolyte out of the battery cell

While it is sometimes possible to replace the lost content of battery electrolyte by adding distilled water, it is a more difficult task to restore battery electrolyte which escapes from the typical battery. However, the present invention produces a means for reintroducing the escaped electrolyte by causing the escaping gases with the entrained electrolyte to travel upwardly through the breather slot 27 and thence into the housing 16. The transient gases are allowed to easily flow through the channels between the wall members 38 and to contact the outer surfaces of wall members 32 disposed in the zone between the outer wall 28 and inner wall 30. These members 38 may be formed of a plastic substance, for example. The entrained electrolyte in the transient gases is typically in the form of small droplets, and will condense and agglomerate to form larger drops on the outer surfaces of the members 38. The member electrolyte will drip back down through the apertures 36 and return to the electrolyte content within the interior of the jar 12.

It will be appreciated that the above described invention is effective in returning electrolyte to the battery. Some of the gases produced in the battery will nevertheless tend to escape through the vented cap provided to close the fill tube 26. However, the present invention has been found to surprisingly substantially reduce the frequency of adding fluid to the battery. The reduction of flow of electrolyte into the atmosphere creates a safer environment by the reduction of airborne articles in the air caused by the escaping gases.

Due to the design of the dielectric fluid retention device of the invention, the uppermost edges of the walls 28 and 30 of the housing 16 are configured to facilitate ultrasonic attachment to the undersurface of the cover of lid 14.

By removal of the vent plug or cover from the fill tube 26, maintenance personnel may readily observe the level of the dielectric fluid within the battery case without any obstructions.

Further, the dielectric fluid retention system of the invention assists in maintaining the top of the battery free from moisture and will materially reduce the likelihood of any undesirable equipment grounding which otherwise might occur.

The present invention has produced an electric storage battery in which the loss of electrolyte is minimized and, therefore, extends the duty life of such batteries.

In accordance with the provisions of the patent statutes, the present invention has been described in what is considered to represent its preferred embodiment. However, it should be understood that the invention can be practiced otherwise than as specifically illustrated and described without departing from its spirit or scope.

1. A housing for the retention of dielectric fluid in a storage battery including an open top jar for dielectric fluid, said housing comprising:
a cover having an undersurface attached to the open top of the jar, said cover including filler means communicating with the interior of the jar;
a bottom wall attached to said cover and defining a zone for the passage of transient gases from the interior of the jar, said bottom wall including apertures communicating with the interior of the jar; and
wall means forming channels in the zone for directing the transient gases, said wall means adapted to collect dielectric fluid from the transient gases and causing the collected dielectric fluid to return to the jar through the apertures in said bottom wall.

2. A housing as defined in claim 1 wherein said cover and said bottom wall are formed of plastic material.

3. A housing as defined in claim 2 wherein said plastic material is polypropylene.

4. A housing as defined in claim 2 wherein said cover and said bottom wall are attached together by an ultrasonic wall.

5. A housing as defined in claim 1 wherein said bottom wall includes a planar section and a first upstanding wall completely surrounding the planar section.

6. A housing as defined in claim 5 wherein said bottom wall includes a second upstanding wall spaced inwardly from the first upstanding wall and surrounds the filler means of said cover.

7. A housing as defined in claim 6 wherein the second upstanding wall is provided with openings providing communications between the interior of the jar and the channels formed by said wall means.

8. A housing as defined in claim 7 wherein said wall means includes irregularly shaped vertically extending surfaces.

9. A housing as defined in claim 7 wherein said wall means is formed in the shape of a plurality of juxtaposed columns.

10. A housing as defined in claim 9 wherein the columns of said wall means are right circular cylinders.

11. A housing as defined in claim 8 wherein the irregularly shaped vertically extending surfaces are in the shape of juxtaposed ribs.
